(19) United States
(12) Patent Application Publication
(10) Pub. No.: US 2025/0093099 A1
(43) Pub. Date: Mar. 20, 2025

(54) DRYING DEVICE AND RECORDING DEVICE

(71) Applicant: SEIKO EPSON CORPORATION, Tokyo (JP)

(72) Inventor: Tadashi AIZAWA, MATSUMOTO-SHI (JP)

(21) Appl. No.: 18/886,267

(22) Filed: Sep. 16, 2024

(30) Foreign Application Priority Data
Sep. 19, 2023 (JP) 2023-150800

(51) Int. Cl. F26B 23/04; H05B 6/54; H05B 6/62

(52) U.S. Cl. CPC F26B 23/04; H05B 6/54; H05B 6/62

(57) ABSTRACT

A drying device includes a plurality of drying sections configured to dry an object. Each of the plurality of drying sections includes a first electrode, a second electrode arranged to surround the first electrode in a plan view from a first direction toward the object, a first conductor configured to electrically connect a transmission line configured to transmit a high-frequency voltage and the first electrode, and a second conductor configured to electrically connect the transmission line and the second electrode. The plurality of drying sections include a first drying section and a second drying section. The first drying section and the second drying section are disposed to be adjacent to each other in a second direction, which intersects the first direction. A normal phase high-frequency voltage is applied to the first electrode of the first drying section and the second electrode of the second drying section.

The present application is based on, and claims priority from JP Application Serial Number 2023-150800, filed Sep. 19, 2023, the disclosure of which is hereby incorporated by reference herein in its entirety.

### BACKGROUND

### 1. Technical Field

The present disclosure relates to a drying device and a recording device.

### 2. Related Art

For example, a drying device that dries an object by generating the electromagnetic waves with respect to the object, such as JP-A-2017-16742, is disclosed. Such a drying device can cause the object to generate heat by supplying a high-frequency voltage between a first electrode and a second electrode to generate the electromagnetic waves with respect to the object.

However, since the heating area is limited in such a drying device, when a heating object having a large area, it is effective to arrange a large number of drying devices. At this time, there is a possibility that the increase of radiation waves may affect the peripheral device. Therefore, it is desired to suppress the influence on surroundings due to the generation of the electromagnetic waves.

### SUMMARY

A drying device to solve the above problem includes a plurality of drying sections configured to dry an object by generating electromagnetic waves in response to the application of a high-frequency voltage, wherein each of the plurality of drying sections includes a first electrode, a second electrode disposed so as to surround the first electrode in plan view from a first direction toward the object, a first conductor that has a coil and that is configured to electrically connect a transmission line configured to transmit the high-frequency voltage to the first electrode, and a second conductor configured to electrically connect the transmission line and the second electrode, the drying sections include a first drying section and a second drying section, the first drying section and the second drying section are disposed to be adjacent to each other in a second direction, which intersects the first direction, and a normal phase high-frequency voltage is applied to the first electrode of the first drying section and the second electrode of the second drying section.

A recording device for solving the above problem, the recording device includes a recording section configured to record on a medium by ejecting liquid onto the medium and a plurality of drying sections configured to dry the medium recorded by the recording section by generating electromagnetic waves in response to the application of a high-frequency voltage, wherein each of the plurality of drying sections includes a first electrode, a second electrode disposed so as to surround the first electrode in plan view from a first direction toward the medium recorded by the recording section, a first conductor that has a coil and that is configured to electrically connect a transmission line configured to transmit the high-frequency voltage to the first electrode, and a second conductor configured to electrically connect the transmission line and the second electrode, the drying sections include a first drying section and a second drying section, the first drying section and the second drying section are disposed to be adjacent to each other in a second direction, which intersects the first direction, and a normal phase high-frequency voltage is applied to the first electrode of the first drying section and the second electrode of the second drying section.

### BRIEF DESCRIPTION OF THE DRAWINGS

FIG. 1 is a schematic diagram showing a recording system of a first embodiment.

FIG. 2 is a schematic diagram showing a drying unit of the first embodiment.

FIG. 3 is a perspective diagram showing a drying section of the first embodiment.

FIG. 4 is a schematic view showing the drying unit of the first embodiment.

FIG. 5 is a block diagram showing a drying device of the first embodiment.

FIG. 6 is a graph showing the relationship between the drying section and an unnecessary radiation waves of the first embodiment.

FIG. 7 is a block diagram showing the drying device according to a second embodiment.

### DESCRIPTION OF EMBODIMENTS

### First Embodiment

Hereinafter, one embodiment of a recording system including a drying device will be described. In the following description, a direction, which intersects a vertical direction z is referred to as a width direction X and a direction, which intersects the vertical direction Z and a width direction X is referred to as a depth direction Y. One direction along the width direction X is referred to as a first width direction X1 and the other direction along the width direction X is referred to as a second width direction X2. One direction along the depth direction Y is defined as a first depth direction Y1 and the other direction along the depth direction Y is defined as a second depth direction Y2. Among the vertical direction Z, the upper side is referred to as an upper side Z1 and the lower side is referred to as a lower side Z2. The vertical direction Z corresponds to an example of a first direction. The width direction X corresponds to an example of a second direction. The depth direction Y corresponds to an example of a third direction.

### Configuration of a Recording System 10

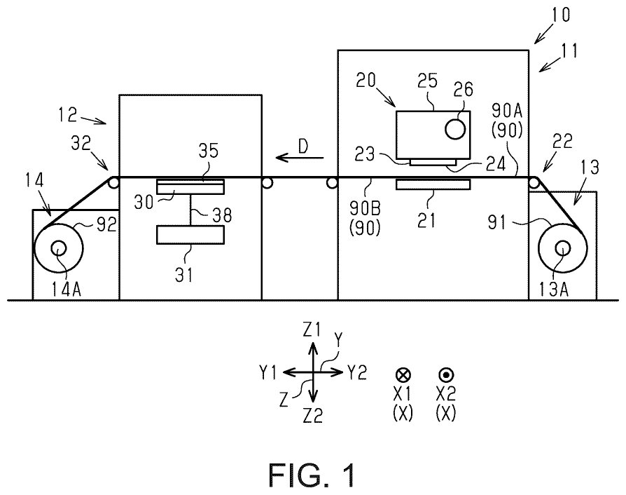

As shown in FIG. 1, the recording system 10 is a system for recording on a medium 90. In particular, the recording system 10 is a system that performs recording on the medium 90 by ejecting liquid onto the medium 90. The recording system 10 is a system that dries the medium 90 on which recording has been performed by ejecting a liquid.

The recording system 10 includes a recording device 11. The recording device 11 is configured to perform recording on the medium 90. In particular, the recording device 11 performs recording on the medium 90 by ejecting liquid onto the medium 90. The recording device 11 may be an inkjet printer that performs recording by ejecting ink, which is an example of a liquid, onto the medium 90. The medium 90 has a front surface 90A and a back surface 90B. The medium 90 is fabric but may be, for example, paper.

The recording system 10 includes a drying device 12. The drying device 12 is configured to dry the medium 90 after the recording in which the recording device 11 ejected the liquid. In particular, by the drying device 12 generates electromagnetic waves to dry the medium 90 after recording.

The recording system 10 includes a feeding section 13. The feeding section 13 feeds the medium 90 before recording to the recording device 11. The feeding section 13 includes a feed roller 13A. The feed roller 13A extends so as to along the width direction X. In the width direction X, the width of the feed roller 13A is longer than the width of the medium 90. The feed roller 13A is configured to rotatably hold a first roll body 91. The first roll body 91 is the medium 90 before recording which is wound and stacked. The medium 90 may be elongated. In this way, the feed roller 13A holds the medium 90 to be fed to the recording device 11.

The recording system 10 includes a winding section 14. The winding section 14 winds up the medium 90 that has been recorded by the recording device 11. In particular, the winding section 14 winds up the medium 90 after recording, which has been dried by the drying device 12. The winding section 14 includes a winding roller 14A. The winding roller 14A is extended along the width direction X. In the width direction X, the width of the winding roller 14A is longer than the width of the medium 90. The winding roller 14A is configured to rotatably hold a second roll body 92. The second roll body 92 is the medium 90 after recording which is wound and stacked. In this way, the winding roller 14A winds up the medium 90 that has been recorded by the recording device 11 and dried by the drying device 12.

### Configuration of the Recording Device 11

Here, the configuration of the recording device 11 will be described in detail.

The recording device 11 includes a recording section 20, a support section 21, and a recording transport section 22. The recording section 20 is configured to perform recording on the medium 90 by ejecting the liquid onto the medium 90. The recording section 20 is configured to perform recording on the medium 90 by ejecting the liquid onto the front surface 90A of the medium 90. The recording section 20 performs recording on the medium 90 supported by the support section 21. The recording section 20 perform recording on the medium 90 transported by the recording transport section 22.

The recording section 20 includes a head 23. The head 23 may be a serial head, or may be a line head. The serial head is a head that scans in the width direction X of the medium 90. The line head is a head that records simultaneously over the width direction X of the medium 90.

The head 23 includes a nozzle surface 24 in which a plurality of nozzles (not shown) are opened. The nozzle surface 24 is a surface facing the lower side Z2. The nozzle surface 24 is a surface facing the front surface 90A of the medium 90 transported by the recording transport section 22. Each of the plurality of nozzles is configured to open on the lower side Z2. Each of the plurality of nozzles is configured to eject the liquid.

The recording section 20 may include a carriage 25 and a carriage support section 26. The carriage 25 is configured to support a head 23. The carriage support section 26 is extended so as to along the width direction X. The carriage support section 26 supports the carriage 25 so as to be movable along the width direction X. The carriage 25 is movable in the width direction X along the carriage support section 26 by driving force from a driving source (not shown).

The support section 21 is configured to support the medium 90 transported by the recording transport section 22. The support section 21 is positioned at the lower side 22 of the recording section 20. The support section 21 supports the back surface 90B of the medium 90 transported by the recording transport section 22. The support section 21 is positioned at the lower side Z2 of the head 23.

The recording transport section 22 is configured to transport the medium 90 in a transport direction D. The transport direction D is a direction along the depth direction Y. The recording transport section 22 may include a plurality of rollers. Although the recording transport section 22 transports the medium 90 in the transport direction D using the plurality of rollers, the recording transport section 22 may transport the medium 90 in the transport direction D using a transport belt driven by the plurality of rollers. The recording transport section 22 may perform intermittent transport in which the transport and stop of the medium 90 are repeated.

### Configuration of the Drying Device 12

Next, the structure of the drying device 12 will be described in detail.

The drying device 12 includes a drying unit 30. The drying unit 30 is configured to dry the medium 90 after recording. That is, the drying device 12 uses the medium 90 recorded by the recording section 20 as an object to be dried.

The drying unit 30 is configured to dry the medium 90 after recording by the generation of the electromagnetic waves. The drying unit 30 is positioned on the lower side Z2 of the medium 90, but may be positioned on the upper side z1 of the medium 90, or may be positioned located both on the upper side Z1 and on the lower side 22 of the medium 90. In this way, the vertical direction Z is a direction toward the medium 90.

The drying device 12 includes a high-frequency voltage generation unit 31. The high-frequency voltage generation unit 31 is configured to generate a high-frequency voltage. The high-frequency voltage generation unit 31 supplies the high-frequency voltage to the drying unit 30. The high-frequency voltage generation unit 31 may include a plurality of high-frequency voltage generation sections 39 (to be described later).

The drying device 12 includes a drying transport section 32. The drying transport section 32 is configured to transport the medium 90 in the transport direction D. The drying transport section 32 may transport the medium 90 in the transport direction D using a plurality of rollers. The drying transport section 32 may perform consecutive transport for consecutively transporting the medium 90. Slackening of the medium 90 may occur between the recording transport section 22 and the drying transport section 32.

### Configuration of the Drying Unit 30

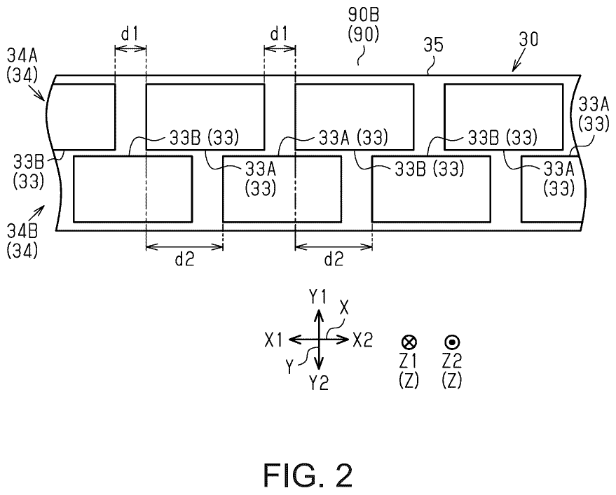

Next, the structure of the drying unit 30 will be described with reference to FIG. 2.

As shown in FIG. 2, the drying unit 30 is disposed on the lower side Z2 below the medium 90. The drying unit 30 dries the medium 90 by heating the medium 90 from the back surface 90B. The drying unit 30 includes a plurality of drying sections 33. That is, the drying device 12 includes the plurality of drying sections 33. The drying section 33 may be rectangular in plan view.

The drying section 33 is configured to generate the electromagnetic waves in response to the application of the high-frequency voltage. The drying section 33 is configured to dry the medium 90 by generating the electromagnetic waves in response to the application of the high-frequency voltage. That is, the drying section 33 is the electromagnetic wave generation section. The drying section 33 generates an alternating electric field by the generation of the electromagnetic waves. The electromagnetic waves generated by the drying section 33 are mainly composed of electric fields. The drying section 33 can greatly reduce the induction of a magnetic field due to the generated electric fields as compared with the electromagnetic wave generation section that generates normal electromagnetic waves.

As a specific example, the drying section 33 generates the electromagnetic waves of 2.4 GHz, but is not limited to this. The drying section 33 may generate, for example, the electromagnetic waves of 3 MHz to 300 MHz. The drying section 33, for example, may generate the electromagnetic waves of 300 MHz to 30 GHz and may generate the electromagnetic waves of 10 MHz to 20 GHz among them.

The drying section 33 includes a plurality of first drying sections 33A and a plurality of second drying sections 33B. The first drying section 33A and the second drying section 33B themselves are configured in the same manner. a reverse phase high-frequency voltage is applied to the first drying section 33A and the second drying section 33B. In this way, drying section 33 includes the plurality of first drying sections 33A and the plurality of second drying sections 33B. The plurality of drying sections 33 may include the same number of first drying sections 33A and second drying sections 33B.

The plurality of drying sections 33 are disposed so as to be aligned in the width direction X in each of the multiple rows 34. The multiple rows 34 are rows aligned side by side in the depth direction Y. The multiple rows 34 include a first row 34A and a second row 34B. The plurality of drying sections 33 are disposed such that their long sides extend along the width direction X in a plan view. The plurality of drying sections 33 are disposed so as to be separated from each other by a distance d1 in the width direction X in each of the multiple rows 34.

The plurality of first drying sections 33A and the plurality of second drying sections 33B are disposed so as to be aligned alternately in the width direction X. Specifically, in each of the first row 34A and the second row 34B, the plurality of first drying sections 33A and the plurality of second drying sections 33B are disposed so as to be aligned alternately in the width direction X. That is, the first drying section 33A and the second drying section 33B are disposed so as to be adjacent to each other in the width direction X.

The drying sections 33 of the first row 34A and the drying sections 33 of the second row 34B are disposed at positions offset by a predetermined distance d2 in the width direction X. Specifically, the first drying sections 33A of the first row 34A and the first drying sections 33A of the second row 34B are disposed at positions separated by the predetermined distance d2 in the width direction X. The second drying sections 33B of the first row 34A and the second drying sections 33B of the second row 34B are disposed at positions separated by the predetermined distance d2 in width direction X.

The predetermined distance d2 is longer than the distance d1. Therefore, even when the plurality of drying sections 33 are disposed at intervals of the distance d1 in the width direction X in each of the first row 34A and the second row 34B, it is possible to dispose the plurality of drying sections 33 without providing a region in which the drying sections 33 are not disposed in the depth direction Y.

The drying unit 30 includes an opposing section 35. The opposing section 35 is positioned between the medium 90 and the plurality of drying sections 33. The opposing section 35 may have a flat plate shape. The opposing section 35 is made of a material that transmits the electromagnetic waves generated by the plurality of drying sections 33. The opposing section 35 is disposed so as to face the back surface 90B of the medium 90. The opposing section 35 may be in contact with the medium 90 and may not be in contact with the medium 90. The opposing section 35 protects the plurality of drying sections 33. The opposing section 35 is composed of a member having an insulating property. The opposing section 35 may be a glass plate. The opposing section 35 may be a ceramic with high transmittance. The opposing section 35 may be made of a resin with a low dielectric dissipation factor.

### Configuration of the Drying Section 33

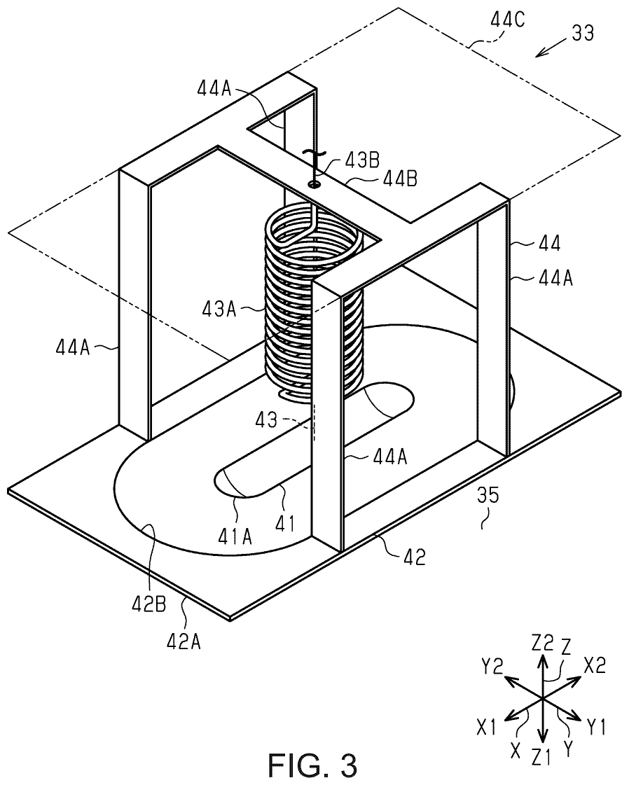

Next, the structure of the drying section 33 will be described in detail with reference to FIG. 3.

As shown in FIG. 3, the drying section 33 includes a first electrode 41, a second electrode 42, a first conductor 43, and a second conductor 44. FIG. 3 is a diagram excluding a top plate 44C of the second conductor 44 for convenience. FIG. 3 is a diagram in which the first electrode 41 and the second electrode 42 are arranged on the upper side Z1.

The first electrode 41 has a flat plate shape. The first electrode 41 may have a rectangular shape in which the width direction X is the longitudinal direction in a plan view. The first electrode 41 includes a first electrode surface 41A. The first electrode surface 41A is a surface facing the upper side Z1. That is, the first electrode surface 41A is a surface facing the back surface 90B of the medium 90. The first electrode 41 is disposed so that the first electrode surface 41A is in contact with the opposing section 35.

The second electrode 42 has a flat plate shape. The second electrode 42 includes a second electrode surface 42A. The second electrode surface 42A is a surface facing the upper side Z1. That is, the second electrode surface 42A is a surface facing the back surface 90B of the medium 90. The second electrode 42 is disposed so that the second electrode surface 42A is in contact with the opposing section 35.

The second electrode 42 is provided with an opening section 42B. The opening section 42B has a rounded rectangular shape in a plan view. The first electrode 41 is positioned in the opening section 42B. That is, the second electrode 42 is disposed so as to surround the first electrode 41 in a plan view from the vertical direction Z.

The first conductor 43 is configured to electrically connect a transmission line 38 (to be described later) and the first electrode 41. The first conductor 43 includes a coil 43A. The coil 43A extends in the vertical direction Z. One end of the coil 43A is connected to the first electrode 41. The other end of the coil 43A is connected to a conductive wire 43B.

The second conductor 44 is configured to electrically connect the transmission line 38 (to be described later) and the second electrode 42. The second conductor 44 may include a support 44A. The second conductor 44 may include a plurality of supports 44A. The support 44A is electrically connected to the second electrode 42. The support 44A extends from the second electrode 42 to the lower side Z2. The support 44A is made of metal.

The second conductor 44 may include a connection section 44B. The connection section 44B is electrically connected to the support 44A. The connection section 44B is provided at a lower end portion of the support 44A. The connection section 44B connects a plurality of supports 44A. The connection section 44B may be integral with the support 44A. The connection section 44B may be H-shaped in a plan view. The connection section 44B is made of metal.

The second conductor 44 may include the top plate 44C. Since the first electrode 41 and the second electrode 42 are disposed on the upper side Z1, the top plate 44C is positioned on the lower side Z2 of the connection section 44B. The top plate 44C is electrically connected to the connection section 44B. The top plate 44C is provided on the lower side Z2 of the connection section 44B. The top plate 44C may be integral with the connection section 44B. The top plate 44C is made of metal.

By configuring the drying section 33 in this way, when the high-frequency voltage is applied to the first electrode 41 and the second electrode 42, the first electrode 41 and the second electrode 42 heat the medium 90 by generating the electromagnetic waves according to the application of the high-frequency voltage.

The drying section 33 can transmit a large amount of heat energy to the medium 90 due to the generation of the electromagnetic waves. The drying section 33 is not of a heat conduction type but of an electromagnetic wave type, and may not include a member such as a heating wire for heating. This makes it possible to reduce the size of the drying section 33.

The minimum separation distance between the first electrode 41 and the second electrode 42 is equal to or less than 1/10 of the wavelength of the electromagnetic waves output from the drying section 33. Thus, the electromagnetic waves generated when the high-frequency voltage is applied can be attenuated in the vicinity of the first electrode 41 and the second electrode 42. This makes it possible to reduce the intensity of the electromagnetic waves that reach a distant place from the first electrode 41 and the second electrode 42. That is, the electromagnetic waves generated from the drying section 33 is very strong in the vicinity of the first electrode 41 and the second electrode 42, and is very weak in a distant place.

Such the drying section 33, by a frequency band of the electromagnetic waves to be generated is appropriately controlled, it is possible to intensively generate an AC electric field in the vicinity of the first electrode 41 and the second electrode 42. In other words, it is possible to suppress the influence on surroundings accompanying the generation of the electromagnetic waves beyond the vicinity of the first electrode 41 and the second electrode 42. As the vicinity of the first electrode 41 and the second electrode 42, for example, the range of 3 mm to 3 cm may correspond.

### Connection Method of the Drying Section 33

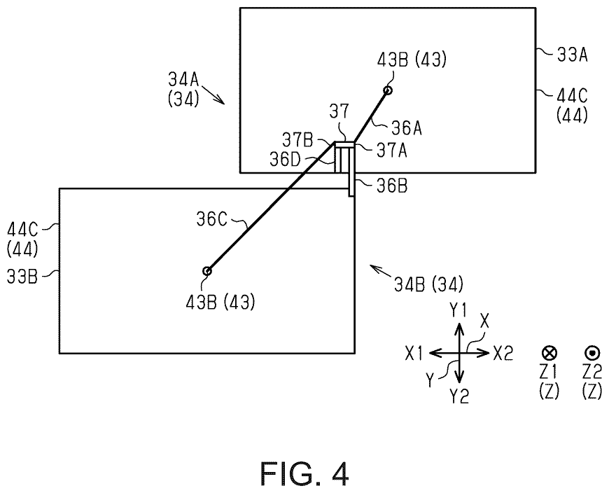

Next, the connection method of the drying section 33 will be described with reference to FIG. 4. FIG. 4 is a diagram showing one first drying section 33A and one second drying section 33B and omitting the other drying sections 33 for convenience.

As shown in FIG. 4, the first drying section 33A and the second drying section 33B are connected to a connection terminal 37. More specifically, the first drying section 33A in the first row 34A and the second drying section 33B in the second row 34B are connected to the connection terminal 37. The first drying section 33A and the second drying section 33B that overlap each other in the depth direction Y are connected to the connection terminal 37.

The connection terminal 37 includes a first terminal 37A and a second terminal 37B. The first terminal 37A and the second terminal 37B are insulated. The transmission line 38 (to be described later) is connectable to the first terminal 37A and the second terminal 37B.

The first conductor 43 of the first drying section 33A is connected to the first terminal 37A via a first connecting section 36A. The second conductor 44 of the first drying section 33A is connected to the second terminal 37B via the second connecting section 36B.

On the other hand, the first conductor 43 of the second drying section 33B is connected to the second terminal 37B via the third connecting section 36C. The second conductor 44 of the second drying section 33B is connected to the first terminal 37A via the fourth connecting section 36D.

In this way, the first conductor 43 of the first drying section 33A and the second conductor 44 of the second drying section 33B are electrically connected via the first terminal 37A. The second conductor 44 of the first drying section 33A and the first conductor 43 of the second drying section 33B are electrically connected via the second terminal 37B.

### Electrical Configuration of the Drying Device 12

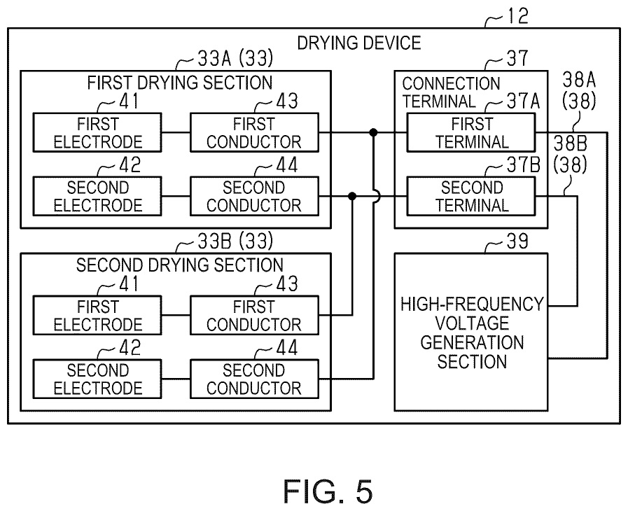

Next, the electrical configuration of the drying device 12 will be described with reference to FIG. 5. Here, in order to facilitate understanding of the disclosure, one first drying section 33A, one second drying section 33B, one connection terminal 37, one transmission line 38, and one high-frequency voltage generation section 39 will be representatively described and description of the other configurations will be omitted. FIG. 5 is a diagram showing one first drying section 33A, one second drying section 33B, one connection terminal 37, one transmission line 38, and one high-frequency voltage generation section 39.

As shown in FIG. 5, the drying device 12 includes the first drying section 33A, the second drying section 33B, the connection terminal 37, a transmission line 38, and the high-frequency voltage generation section 39. In the first drying section 33A and the second drying section 33B, the first electrode 41 and the first conductor 43 are connected. In the first drying section 33A and the second drying section 33B, the second electrode 42 and the second conductor 44 are connected.

The first conductor 43 of the first drying section 33A is connected to the first terminal 37A of the connection terminal 37. The second conductor 44 of the first drying section 33A is connected to the second terminal 37B of the connection terminal 37. The first conductor 43 of the second drying section 33B is connected to the second terminal 37B of the connection terminal 37. The second conductor 44 of the second drying section 33B is connected to the first terminal 37A of the connection terminal 37. In the connection terminal 37, the first terminal 37A is connected to a first line 38A of the transmission line 38. The second terminal 37B is connected to a second line 38B of the transmission line 38.

The transmission line 38 is a line that connects the first drying section 33A and the second drying section 33B to the high-frequency voltage generation section 39. The transmission line 38 is a line for transmitting the high-frequency voltage generated by the high-frequency voltage generation section 39 to the first drying section 33A and the second drying section 33B. That is, the transmission line 38 is capable of transmitting the high-frequency voltage.

The transmission line 38 may be a coaxial cable, but is not limited to the coaxial cable. The transmission line 38 may provide the first line 38A and the second line 38B. The first line 38A may be a core wire of the transmission line 38. The second line 38B may be an electromagnetic shield that covers the first line 38A.

The high-frequency voltage generation section 39 is included in the high-frequency voltage generation unit 31. The high-frequency voltage generation section 39 is configured to generate the high-frequency voltage. The high-frequency voltage generation section 39 can supply the high-frequency voltage to the first drying section 33A and the second drying section 33B via the transmission line 38 and the connection terminal 37.

With this configuration, the high-frequency voltage generation section 39 applies the high-frequency voltage to the plurality of drying sections 33. In particular, the high-frequency voltage generation section 39 is configured to apply the high-frequency voltage to both the first drying section 33A and the second drying section 33B.

The first electrode 41 of the first drying section 33A is the reverse phase with the first electrode 41 of the second drying section 33B. The second electrode 42 of the second drying section 33B is the reverse phase of the first electrode 41 of the second drying section 33B. The first electrode 41 of the first drying section 33A is in a normal phase with the second electrode 42 of the second drying section 33B. The second electrode 42 of the first drying section 33A is in the normal phase with the first electrode 41 of the first drying section 33A.

In this way, the normal phase high-frequency voltage is applied to the first electrode 41 of the first drying section 33A and the second electrode 42 of the second drying section 33B. That is, the reverse phase high-frequency voltage is applied to the first drying section 33A and the second drying section 33B.

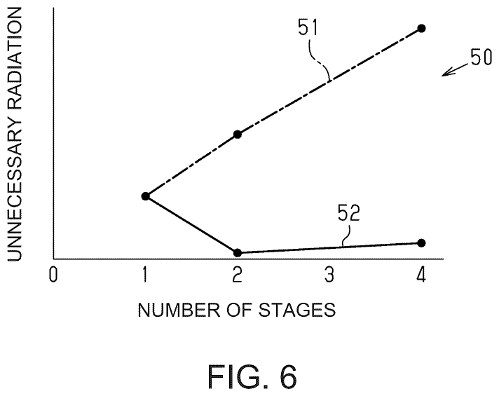

Next, the relationship between the number of drying sections 33 and the unnecessary radiation waves will be described with reference to FIG. 6. FIG. 6 is a graph 50 showing the relationship between the number of drying sections 33 and unnecessary radiation waves in the related embodiment and the first embodiment. In FIG. 6, a graph 51 showing the relationship between the number of drying sections 33 and the unnecessary radiation waves in the related embodiment is shown by an one dot chain line. In FIG. 6, a graph 52 showing the relationship between the number of drying sections 33 and the unnecessary radiation waves in the first embodiment is shown by a solid line.

In the related embodiment, the first electrode 41 of the first drying section 33A and the first electrode 41 of the second drying section 33B are the normal phases. In the related embodiment, the second electrode 42 of the second drying section 33B and the first electrode 41 of the second drying section 33B are normal phases. In the related embodiment, the first electrode 41 of the first drying section 33A and the second electrode 42 of the second drying section 33B are the reverse phases. In the related embodiment, the second electrode 42 of the first drying section 33A and the first electrode 41 of the first drying section 33A are the reverse phases.

On the other hand, in the first embodiment, the first electrode 41 of the first drying section 33A and the first electrode 41 of the second drying section 33B are the reverse phases. In the first embodiment, the second electrode 42 of the second drying section 33B and the first electrode 41 of the second drying section 33B are the reverse phase. In the first embodiment, the first electrode 41 of the first drying section 33A and the second electrode 42 of the second drying section 33B are normal phases. In the first embodiment, the second electrode 42 of the first drying section 33A and the first electrode 41 of the first drying section 33A are normal phases.

In such a configuration, in the case of the related embodiment, the greater the number of drying sections 33 are, the greater the unwanted radiation waves are, in proportion. On the other hand, in the case of the first embodiment, even when the number of drying sections 33 increases, the unnecessary radiation waves do not increase in proportion. In the case of the first embodiment, such an event is caused by the radiation waves from the first drying section 33A and the radiation waves from the second drying section 33B cancel each other.

### Operation and Effect of the First Embodiment

The operation and effect of the first embodiment will be described.

(1-1) The drying device 12 includes the plurality of drying sections 33 that dry the medium 90 by generating the electromagnetic waves in response to the application of the high-frequency voltage. The drying section 33 includes the first drying section 33A and the second drying section 33B. The first drying section 33A and the second drying section 33B are disposed so as to be adjacent to each other in the width direction X. The normal phase high-frequency voltage is applied to the first electrode 41 of the first drying section 33A and the second electrode 42 of the second drying section 33B. According to this configuration, in the first drying section 33A and the second drying section 33B disposed so as to be adjacent to each other in the width direction X, the radiation waves from the first drying section 33A and the radiation waves from the second drying section 33B cancel each other. As a result, since the radiation waves can be suppressed, it is possible to suppress the influence the peripheral devices. Therefore, it is possible to suppress the influence on surroundings due to the generation of the electromagnetic waves.

In particular, in a neighboring region where the first drying section 33A is disposed, the radiation waves from the first drying section 33A are significantly larger than the radiation waves from the second drying section 33B aligned with the first drying section 33A. Therefore, in the neighboring region where the first drying section 33A is disposed, the radiation waves from the first drying section 33A are not greatly affected by the radiation waves from the second drying section 33B aligned with the first drying section 33A. Accordingly, the radiation waves in the neighboring region where the first drying section 33A is disposed and the radiation waves in the neighboring region where the second drying section 33B is disposed do not largely cancel each other, and the drying qualities are not reduced.

On the other hand, the radiation waves at a position farther than the first drying section 33A and the radiation waves at a position farther than the second drying section 33B cancel each other. In particular, the drying device 12 includes the plurality of drying sections 33 for drying the medium 90. Therefore, even at a distance from the drying section 33, when the radiation waves from the drying section 33 are amplified by each other, there is a risk that the increase of the radiation waves may affect the peripheral devices. Therefore, by adopting the above configuration, it is possible to suppress the radiation waves even when it is farther than the drying section 33, so that it is possible to suppress the influence on the peripheral devices. Therefore, it is possible to suppress the influence on surroundings due to the generation of the electromagnetic waves.

(1-2) The plurality of drying sections 33 include the plurality of first drying sections 33A and the plurality of second drying sections 33B. The plurality of first drying sections 33A and the plurality of second drying sections 33B are disposed so as to be aligned alternately in the width direction X. According to this configuration, in the plurality of first drying sections 33A and the plurality of second drying sections 33B are disposed so as to be aligned alternately in the width direction X, the radiation waves from the first drying section 33A and the second drying section 33B cancel each other. As a result, since the radiation waves can be suppressed, it is possible to suppress the influence the peripheral devices. Therefore, it is possible to suppress the influence on surroundings due to the generation of the electromagnetic waves.

(1-3) In each of the first row 34A and the second row 34B aligned side by side in the depth direction Y, the plurality of first drying sections 33A and the plurality of second drying sections 33B are disposed so as to be aligned alternately in the width direction X. The first drying sections 33A of the first row 34A and the first drying sections 33A of the second row 34B are disposed at positions separated by the predetermined distance d2 in the width direction X. The second drying sections 33B of the first row 34A and the second drying sections 33B of the second row 34B are disposed at positions separated by the predetermined distance d2 in width direction X. According to this configuration, even when the plurality of drying sections 33 are disposed at intervals in the width direction X in each of the first row 34A and the second row 34B, it is possible to make it difficult to provide a region in which the drying sections 33 are not disposed in the depth direction Y. Therefore, it is possible to suppress the influence on surroundings due to the generation of the electromagnetic waves and it is possible to improve the drying quality.

(1-4) The plurality of drying sections 33 include the same number of first drying sections 33A and second drying sections 33B. According to this configuration, it is possible to improve the degree to which the radiation waves from the first drying section 33A and the radiation waves from the second drying section 33B cancel each other. As a result, since the radiation waves can be further suppressed, it is possible to suppress the peripheral device. Therefore, it is possible to suppress the influence on surroundings due to the generation of the electromagnetic waves.

(1-5) The drying device 12 includes the high-frequency voltage generation section 39 for applying the high-frequency voltage to the plurality of drying sections 33. The high-frequency voltage generation section 39 is configured to apply the high-frequency voltage to both the first drying section 33A and the second drying section 33B. According to this configuration, the high-frequency voltage generated by the high-frequency voltage generation section 39 can be applied to both the first drying section 33A and the second drying section 33B. As a result, it is possible to suppress the influence on surroundings due to the generation of the electromagnetic waves and it is possible to reduce the size of the drying device 12.

(1-6) Each of the plurality of drying sections 33 are disposed such that their long side extend along the width direction X in a plan view. According to this configuration, it is possible to make it difficult to provide a region in which the drying sections 33 are not disposed in the depth direction Y without increasing the number of the plurality of drying sections 33. Therefore, it is possible to suppress the influence on surroundings due to the generation of the electromagnetic waves and it is possible to improve the drying quality.

### Second Embodiment

Next, the second embodiment will be described. In the following description, the same configuration as that of the embodiment already described will be omitted or simplified and a configuration different from that of the embodiment already described will be described.

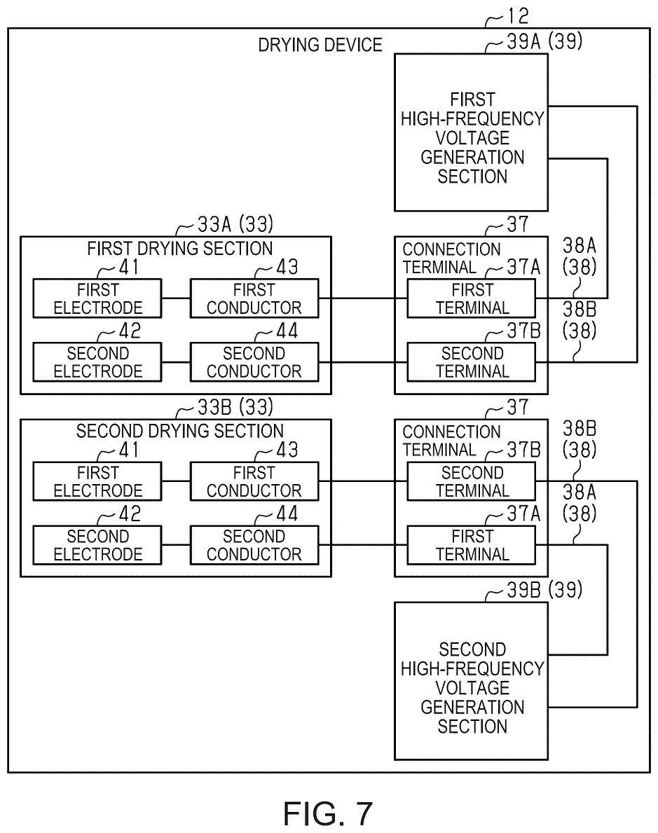

As shown in FIG. 7, in the drying device 12 of the second embodiment, the high-frequency voltage generation section 39 includes a first high-frequency voltage generation section 39A and a second high-frequency voltage generation section 39B. The first high-frequency voltage generation section 39A is connected to the first drying section 33A through the connection terminal 37. The second high-frequency voltage generation section 39B is connected to the second drying section 33B via the connection terminal 37. That is, the high-frequency voltage generation section 39 and the drying section 33 are connected in a one-to-one manner.

The first conductor 43 of the first drying section 33A is connected to the first high-frequency voltage generation section 39A via the first terminal 37A of the connection terminal 37 and the first line 38A of the transmission line 38. The second conductor 44 of the first drying section 33A is connected to the first high-frequency voltage generation section 39A via the second terminal 37B of the connection terminal 37 and the second line 38B of the transmission line 38. The first conductor 43 of the second drying section 33B is connected to the second high-frequency voltage generation section 39B via the second terminal 37B of the connection terminal 37 and the second line 38B of the transmission line 38. The second conductor 44 of the second drying section 33B is connected to the second high-frequency voltage generation section 39B via the first terminal 37A of the connection terminal 37 and the first line 38A of the transmission line 38.

The first high-frequency voltage generation section 39A is configured to generate the high-frequency voltage. The first high-frequency voltage generation section 39A can supply the high-frequency voltage to the first drying section 33A via the transmission line 38 and the connection terminal 37.

The second high-frequency voltage generation section 39B is configured to generate the high-frequency voltage. The second high-frequency voltage generation section 39B can supply the high-frequency voltage to the second drying section 33B via the transmission line 38 and the connection terminal 37.

With this configuration, the high-frequency voltage generation section 39 can apply the high-frequency voltage to each of the plurality of drying sections 33. In particular, the high-frequency voltage generation section 39 is configured to apply the high-frequency voltage to the first drying section 33A by the first high-frequency voltage generation section 39A and apply the high-frequency voltage to the second drying section 33B by the second high-frequency voltage generation section 39B.

The first electrode 41 of the first drying section 33A is the reverse phase with the first electrode 41 of the second drying section 33B. The second electrode 42 of the first drying section 33A is the reverse phase with the second electrode 42 of the second drying section 33B. The first electrode 41 of the first drying section 33A is in a normal phase with the second electrode 42 of the second drying section 33B. The second electrode 42 of the first drying section 33A is the normal phase with the first electrode 41 of the second drying section 33B.

In this way, the normal phase high-frequency voltage is applied to the first electrode 41 of the first drying section 33A and the second electrode 42 of the second drying section 33B. That is, the reverse phase high-frequency voltage is applied to the first drying section 33A and the second drying section 33B.

### Operation and Effect of the Second Embodiment

Operations and effects of the second embodiment will be described.

(2-1) The high-frequency voltage generation section 39 includes the first high-frequency voltage generation section 39A and the second high-frequency voltage generation section 39B. The first high-frequency voltage generation section 39A applies the high-frequency voltage to the first drying section 33A. The second high-frequency voltage generation section 39B applies the high-frequency voltage to the second drying section 33B. According to this configuration, it is possible to apply the high-frequency voltage from the high-frequency voltage generation section 39 to each of the plurality of drying sections 33 on a one-to-one manner. Therefore, it becomes easy to apply the high-frequency voltage of sufficient intensity. As a result, it is possible to suppress the influence on surroundings due to the generation of the electromagnetic waves and it is possible to reduce the size of the drying device 12.

### MODIFICATION EXAMPLES

The present embodiment can be implemented with the following modifications. The present embodiment and the following modification examples can be implemented in combination with each other within a technically compatible range.
The drying device 12 may connect two or more first drying sections 33A and two or more second drying sections 33B to the connection terminal 37. In this case, the drying device 12 may be configured to apply the high-frequency voltage from one high-frequency voltage generation section 39 to the connection terminal 37 in a state of connecting the connection terminal 37 and the high-frequency voltage generation section 39. Thus, it is possible to apply the high-frequency voltage from one high-frequency voltage generation section 39 to two or more r first drying sections 33A and two or more second drying sections 33B.
The multiple rows 34 may be three or more rows. In other words, the plurality of drying section 33 may be disposed in three or more rows. The plurality of drying sections 33 may be disposed in a single row. The plurality of drying sections 33 may be disposed such that their long sides extend along the depth direction Y as viewed from the vertical direction Z. In this case, it is possible to reduce the number of rows in the depth direction Y in which the plurality of drying sections 33.
As long as the distance between the first electrode 41 and the second electrode 42 and the medium 90 is within a predetermined range, the opposing section 35 may not be in contact with the first electrode 41 and the second electrode 42 on the surface, but may be in contact with the first electrode 41 and the second electrode 42 at a point. The opposing section 35 may not be in contact with the first electrode 41 and the second electrode 42.
At least one of the first electrode 41 or the second electrode 42 is not limited to a flat plate shape, for example, may be a substantially flat plate shape. Generally flat plate shape, for example, the aspect ratio of the shape or rectangular shape curved in the thickness direction is a direction along the vertical direction Z is extremely large, may include a linear shape.
The drying device 12 may include an air blowing section. The air blowing section may blow air along the depth direction Y in order to dry the medium 90. In this case, the air blowing section may blow air so as to stride over the drying unit 30.
The object to be dried by the drying device 12 is not limited to the medium 90 onto which the liquid is ejected as long as the object is heated by transmission of thermal energy due to generation of the electromagnetic waves.

The drying section 33 may include at least one first drying section 33A and at least one second drying section 33B. That is, the drying section 33 may include one or more first drying section 33A and one or more second drying section 33B.
The plurality of drying sections 33 may not be provided in the drying device 12 and may be provided in the recording device 11. That is, the recording device 11 may be provided with the plurality of drying sections 33. In this case, the plurality of drying sections 33 may be provided downstream of the recording section 20 in the transport direction D. In this way, the plurality of drying sections 33 may be applied to the recording device 11 instead of the drying device 12.
A lateral type printer may be adopted as the recording device 11. The lateral type printer is a printer in which the carriage 25 can move in two directions of a main scanning direction and a sub-scanning direction.
The medium 90 is not limited to the roll body. The medium 90 may be a paper sheet, a resin film or sheet, a resin-metal composite film, a laminate film, a woven fabric, a nonwoven fabric, a metal foil, a metal film, a ceramic sheet, clothing, or the like.
The liquid can be arbitrarily selected as long as the liquid can be deposited to the medium to perform recording on the medium. For example, ink includes ink in which particles of a functional material made of a solid material such as a pigment or metal particles are dissolved, dispersed, or mixed in a solvent, and includes various compositions such as water-based ink, oil-based ink, a gel ink, and a hot-melt ink.
As used herein, the phrase “at least one of” means one or more of the desired options. As an example, the phrase “at least one of” as used herein means only one option if the number of options is two, or both of the two options. As another example, the phrase “at least one of” as used herein means only one option or a combination of any two or more options when the number of options is three or more.

### Notes

Hereinafter, technical ideas grasped from the above described embodiment and modification examples, and operations and effects thereof will be described. The present technical idea and the operations and effects thereof can be combined with each other within a technically consistent range.

(A) A drying device includes a plurality of drying sections configured to dry an object by generating electromagnetic waves in response to the application of a high-frequency voltage, wherein each of the plurality of drying sections includes
a first electrode, a second electrode disposed so as to surround the first electrode in plan view from a first direction toward the object, a first conductor that has a coil and that is configured to electrically connect a transmission line configured to transmit the high-frequency voltage to the first electrode, and
a second conductor configured to electrically connect the transmission line and the second electrode, the drying sections include a first drying section and a second drying section, the first drying section and the second drying section are disposed to be adjacent to each other in a second direction, which intersects the first direction, and a normal phase high-frequency voltage is applied to the first electrode of the first drying section and the second electrode of the second drying section.

According to this configuration, in the first drying section and the second drying section, which are disposed to be adjacent to each other in the second direction, the radiation waves from the first drying section and the radiation waves from the second drying section cancel each other. As a result, since the radiation waves can be suppressed, it is possible to suppress the influence the peripheral devices. Therefore, it is possible to suppress the influence on surroundings due to the generation of the electromagnetic waves.

(B) The above described drying device may be such that the plurality of drying sections include a plurality of the first drying sections and a plurality of the second drying sections and
the plurality of the first drying sections and the plurality of the second drying sections are disposed so as to be aligned alternately in the second direction.

According to this configuration, even when equipped the plurality of first drying sections and the plurality of second drying sections, in the plurality of first drying sections and the plurality of second drying sections are disposed so as to be aligned alternately in the second direction, the radiation waves from the first drying sections and the radiation waves from the second drying sections cancel each other. As a result, since the radiation waves can be suppressed, it is possible to suppress the influence the peripheral devices. Therefore, it is possible to suppress the influence on surroundings due to the generation of the electromagnetic waves.

(C) The above described drying device may be such that in each of a first row and a second row aligned side by side in a third direction, which intersects the first direction and the second direction, the plurality of first drying sections and the plurality of second drying sections are disposed so as to be aligned alternately in the second direction, the first drying sections of the first row and the first drying sections of the second row are disposed at positions separated from each other by a predetermined distance in the second direction, and the second drying sections of the first row and the second drying sections of the second row are disposed at positions separated from each other by a predetermined distance in the second direction.

According to this configuration, even when the plurality of drying sections are disposed at intervals in the second direction in each row, it is possible to make it difficult to provide a region in which the drying sections are not disposed in the third direction. Therefore, it is possible to improve the drying quality while suppressing the influence on surroundings due to the generation of the electromagnetic waves.

(D) The above described drying device may be such that the plurality of drying sections are provided with the same number of the first drying sections and the second drying sections.

According to this configuration, it is possible to improve the degree to which the radiation waves from the first drying section and the radiation waves from the second drying section cancel each other. As a result, since the radiation waves can be further suppressed, it is possible to suppress the peripheral device. Therefore, it is possible to suppress the influence on surroundings due to the generation of the electromagnetic waves.

(E) the above described drying device may further includes a high-frequency voltage generation section configured to apply the high-frequency voltage to the plurality of drying sections, wherein the high-frequency voltage generation section is configured to apply the high-frequency voltage to both the first drying section and the second drying section.

According to this configuration, the high-frequency voltage generated by the high-frequency voltage generation section can be applied to both the first drying section and the second drying section. As a result, it is possible to suppress the influence on surroundings due to the generation of the electromagnetic waves, and it is possible to miniaturize the drying device.

(F) The above described drying device may further include a high-frequency voltage generation section configured to apply the high-frequency voltage to the plurality of drying sections, wherein the high-frequency voltage generation section includes a first high-frequency voltage generation section and a second high-frequency voltage generation section, the first high-frequency voltage generation section is configured to apply the high-frequency voltage to the first drying section, and the second high-frequency voltage generation section configured to apply the high-frequency voltage to the second drying section.

According to this configuration, it is possible to apply the high-frequency voltage from the high-frequency voltage generation section to each of the plurality of drying sections on a one-to-one manner. Therefore, it becomes easy to apply the high-frequency voltage of sufficient intensity. As a result, it is possible to suppress the influence on surroundings due to the generation of the electromagnetic waves, and it is possible to miniaturize the drying device.

(G) A recording device includes a recording section configured to record on a medium by ejecting liquid onto the medium and a plurality of drying sections configured to dry the medium recorded by the recording section by generating electromagnetic waves in response to the application of a high-frequency voltage, wherein each of the plurality of drying sections includes a first electrode, a second electrode disposed so as to surround the first electrode in plan view from a first direction toward the medium recorded by the recording section, a first conductor that has a coil and that is configured to electrically connect a transmission line configured to transmit the high-frequency voltage to the first electrode, and a second conductor configured to electrically connect the transmission line and the second electrode, the drying sections include a first drying section and a second drying section, the first drying section and the second drying section are disposed to be adjacent to each other in a second direction, which intersects the first direction, and a normal phase high-frequency voltage is applied to the first electrode of the first drying section and the second electrode of the second drying section.

According to this configuration, it is possible to achieve the same effect as (A).

What is claimed is:

1. A drying device comprising:
a plurality of drying sections configured to dry an object by generating electromagnetic waves in response to the application of a high-frequency voltage, wherein
each of the plurality of drying sections includes
a first electrode,
a second electrode disposed so as to surround the first electrode in plan view from a first direction toward the object,
a first conductor that has a coil and that is configured to electrically connect a transmission line configured to transmit the high-frequency voltage to the first electrode, and
a second conductor configured to electrically connect the transmission line and the second electrode,
the drying sections include a first drying section and a second drying section,
the first drying section and the second drying section are disposed to be adjacent to each other in a second direction, which intersects the first direction, and
a normal phase high-frequency voltage is applied to the first electrode of the first drying section and the second electrode of the second drying section.

2. The drying device according to claim 1, wherein
the plurality of drying sections include a plurality of the first drying sections and a plurality of the second drying sections and
the plurality of the first drying sections and the plurality of the second drying sections are disposed so as to be aligned alternately in the second direction.

3. The drying device according to claim 2, wherein
in each of a first row and a second row aligned side by side in a third direction, which intersects the first direction and the second direction, the plurality of first drying sections and the plurality of second drying sections are disposed so as to be aligned alternately in the second direction,
the first drying sections of the first row and the first drying sections of the second row are disposed at positions offset by a predetermined distance in the second direction, and
the second drying sections of the first row and the second drying sections of the second row are disposed at positions offset by a predetermined distance in the second direction.

4. The drying device according to claim 1, wherein
the plurality of drying sections are provided with the same number of the first drying sections and the second drying sections.

5. The drying device according to claim 1, further comprising:
a high-frequency voltage generation section configured to apply the high-frequency voltage to the plurality of drying sections, wherein
the high-frequency voltage generation section is configured to apply the high-frequency voltage to both the first drying section and the second drying section.

6. The drying device according to claim 1, further comprising:
a high-frequency voltage generation section configured to apply the high-frequency voltage to the plurality of drying sections, wherein
the high-frequency voltage generation section includes a first high-frequency voltage generation section and a second high-frequency voltage generation section,
the first high-frequency voltage generation section is configured to apply the high-frequency voltage to the first drying section, and
the second high-frequency voltage generation section configured to apply the high-frequency voltage to the second drying section.

7. A recording device comprising:
a recording section configured to record on a medium by ejecting liquid onto the medium and
a plurality of drying sections configured to dry the medium recorded by the recording section by generating electromagnetic waves in response to the application of a high-frequency voltage, wherein
each of the plurality of drying sections includes
a first electrode,
a second electrode disposed so as to surround the first electrode in plan view from a first direction toward the medium recorded by the recording section,
a first conductor that has a coil and that is configured to electrically connect a transmission line configured to transmit the high-frequency voltage to the first electrode, and
a second conductor configured to electrically connect the transmission line and the second electrode,
the drying sections include a first drying section and a second drying section,
the first drying section and the second drying section are disposed to be adjacent to each other in a second direction, which intersects the first direction, and
a normal phase high-frequency voltage is applied to the first electrode of the first drying section and the second electrode of the second drying section.
